(19) United States
(12) Patent Application Publication
(10) Pub. No.: US 2012/0230596 A1
(43) Pub. Date: Sep. 13, 2012

(54) IMAGE PROCESSING APPARATUS AND IMAGE PROCESSING METHOD

(76) Inventors: Takahiro Watanabe, Saitama (JP); Tsukasa Kobayashi, Tokyo (JP); Tsutomu Kosasa, Gunma (JP)

(21) Appl. No.: 13/499,284

(22) PCT Filed: Jul. 16, 2010
(86) PCT No.: PCT/JP2010/062123

§ 371 Date: Jun. 1, 2012

(30) Foreign Application Priority Data
Sep. 30, 2009 (JP) 2009-227050

(51) Int. Cl. G06K 9/36

(52) U.S. Cl. 382/232

(57) ABSTRACT

To provide a technology with which it is possible to protect the privacy of a person whose image is captured by a camera and to easily check whether or not the camera is operating properly. An image processing apparatus includes: an image compressing unit that acquires compressed image information by compressing image information that is outputted by a camera and outputs the acquired compressed image information; an image analyzing unit that acquires analyzed information by analyzing the image information that is outputted by the camera and outputs the acquired analyzed information; an output switching unit that outputs, as output information, either one of the compressed image information that is outputted by the image compressing unit and the analyzed information that is outputted by the image analyzing unit; and an output unit that outputs, to another apparatus, the output information that is outputted by the output switching unit.

### TECHNICAL FIELD

The present invention relates to an image processing apparatus and an image processing method. More particularly, the present invention relates to a technology that outputs an image that has been captured by a camera and a result of having processed that image.

### BACKGROUND ART

Conventionally, in technologies that perform surveillance with an image that has been captured by a camera, there have been cases where, for example, in a case where an image of a person has been captured by the camera, problems arise in terms of protecting the privacy of the person whose image has been captured. Therefore, technologies that recognize the position of a face of a person that has been captured in an image that has been captured and administer mask processing to the position of the face or set a mask region to thereby protect the privacy of the person whose image has been captured have been proposed (e.g., see patent document 1 (JP-A No. 2008-197837) and patent document 2 (JP-A No. 2008-097379)).

Further, technologies that process an image that has been captured to thereby recognize the state of a person whose image has been captured and output the recognition result as text information and technologies that simultaneously output, in accordance with the recognition result, text information and image information that has been acquired by a camera have been proposed (e.g., see patent document 3 (JP-A No. 2009-088789)).

### DISCLOSURE OF INVENTION

### Problem to be Solved by the Invention

However, for example, according to the technology disclosed in patent document 1 (JP-A No. 2008-197837), there has been the problem that sometimes privacy is not completely protected, such as in cases where the position of the face is misrecognized in the captured image. Further, for example, according to the technologies disclosed in patent document 1 (JP-A No. 2008-197837) and patent document 2 (JP-A No. 2008-097379), there has been the problem that a lot of time and effort are required to set the mask region because it is necessary to manually set the mask region each time the installation location and installation angle of the camera are changed. Moreover, according to the technologies disclosed in patent document 1 (JP-A No. 2008-197837) and patent document 2 (JP-A No. 2008-097379), there has also been the problem that the mask region becomes invalid each time the installation angle of the camera is changed, and privacy becomes no longer protected.

Further, according to the technology disclosed in patent document 3 (JP-A No. 2009-088789), protecting the privacy of a person whose image has been captured is easy, but there has been the problem that it is difficult to check whether or not the camera is operating properly simply when only text information is outputted. A case where the camera is operating properly is, for example, a case where a location whose image is to be captured is being normally captured. Further, in a cases where misrecognition ends up occurring when an image that has been captured in accordance with the recognition result is simultaneously outputted with text information, there has been the problem that an image in which a person whose privacy is to be protected is captured ends up being mistakenly outputted.

Therefore, the present invention has been made in view of the above problems, and it is an object of the present invention to provide a technology with which it is possible to protect the privacy of a person whose image has been captured by a camera and to easily check whether or not the camera is operating properly.

### Means for Solving the Problem

In order to solve the above problems, according to an aspect of the present invention, there is provided an image processing apparatus that processes image information that is acquired and outputted by a camera, the image processing apparatus including: an image compressing unit that acquires compressed image information by compressing the image information that is outputted by the camera and outputs the acquired compressed image information; an image analyzing unit that acquires analyzed information by analyzing the image information that is outputted by the camera and outputs the acquired analyzed information; an output switching unit that outputs, as output information, either one of the compressed image information that is outputted by the image compressing unit and the analyzed information that is outputted by the image analyzing unit; and an output unit that outputs, to another apparatus, the output information that is outputted by the output switching unit.

The output switching unit may receive a selection from a user and output, as the output information, either one of the compressed image information and the analyzed information in accordance with the received selection.

In a case where the output switching unit outputs the compressed image information as the output information, the output switching unit may cause the image analyzing unit to not perform the analysis of the image information, and in a case where the output switching unit outputs the analyzed information as the output information, the output switching unit may cause the image compressing unit to not perform the compression of the image information.

The output switching unit may perform authentication processing with respect to the user and receive the selection from the user in a case where the authentication processing is successful.

The image analyzing unit may be equipped with a person detecting unit that detects a person existing in an image represented by the image information and acquires person position information for designating a position, in the image, of the detected person, and the image analyzing unit may output the analyzed information including the person position information that is acquired by the person detecting unit.

The image analyzing unit may include a face detecting unit that detects the face of a person existing in an image represented by the image information and acquires face position information for designating a position, in the image, of the detected face, and the image analyzing unit may output the analyzed information including the face position information that is acquired by the face detecting unit.

The image analyzing unit may include a face detecting unit that detects the face of a person existing in an image represented by the image information and acquires face position information for designating a position, in the image, of the detected face and an attribute analyzing unit that acquires attribute information representing attributes of the person by analyzing the face in the position designated by the face position information that is acquired by the face detecting unit, and the image analyzing unit may output the analyzed information including the attribute information that is acquired by the attribute analyzing unit.

The image analyzing unit may include a person detecting unit that detects a person existing in an image represented by the image information and acquires person position information for designating a position, in the image, of the detected person and an action analyzing unit that acquires action information representing an action of the person by analyzing the person in the position designated by the person position information that is acquired by the person detecting unit, and the image analyzing unit may output the analyzed information including the action information that is acquired by the action analyzing unit.

The image analyzing unit may acquire time information representing a time when the image information has been acquired or a time when the image information has been analyzed and output the analyzed information including the acquired time information.

Further, according to another aspect of the present invention, there is provided an image processing apparatus that processes image information that is acquired and outputted by a camera, the image processing apparatus including: an image compressing unit that acquires compressed image information by compressing the image information that is outputted by the camera and outputs the acquired compressed image information; an image analyzing unit that acquires analyzed information by analyzing the image information that is outputted by the camera and outputs the acquired analyzed information; an image synthesizing unit that acquires synthesized information by synthesizing the compressed image information that is outputted by the image compressing unit and the analyzed information that is outputted by the image analyzing unit and outputs the acquired synthesized information; an output switching unit that outputs, as output information, any one of the compressed image information that is outputted by the image compressing unit, the analyzed information that is outputted by the image analyzing unit, and the synthesized information that is outputted by the image synthesizing unit; and an output unit that outputs, to another apparatus, the output information that is outputted by the output switching unit.

In a case where the output switching unit outputs the compressed image information as the output information, the output switching unit may cause the image analyzing unit to not perform the analysis of the image information and cause the image synthesizing unit to not perform the synthesis of the compressed image information and the analyzed information, and in a case where the output switching unit outputs the analyzed information as the output information, the output switching unit may cause the image compressing unit to not perform the compression of the image information and cause the image synthesizing unit to not perform the synthesis of the compressed image information and the analyzed information.

Further, according to another aspect of the present invention, there is provided an image processing apparatus that processes image information that is acquired and outputted by a camera, the image processing apparatus including: an image analyzing unit that acquires analyzed information by analyzing the image information that is outputted by the camera and outputs the acquired analyzed information; an output switching unit that outputs either one of the image information that is outputted by the camera and the analyzed information that is outputted by the image analyzing unit; an image output unit which, in a case where the image information is outputted by the output switching unit, outputs to the other apparatus the outputted image information; and an analyzed information output unit which, in a case where the analyzed information is outputted by the output switching unit, outputs to another apparatus the outputted analyzed information.

Further, according to another aspect of the present invention, there is provided an image processing apparatus that processes image information that is acquired and outputted by a camera, the image processing apparatus including: an image analyzing unit that acquires analyzed information by analyzing the image information that is outputted by the camera and outputs the acquired analyzed information; an image synthesizing unit that acquires synthesized information by synthesizing the image information that is outputted by the camera and the analyzed information that is outputted by the image analyzing unit and outputs the acquired synthesized information; an output switching unit that outputs any one of the image information that is outputted by the camera, the analyzed information that is outputted by the image analyzing unit, and the synthesized information that is outputted by the image synthesizing unit; an image output unit which, in a case where the image information is outputted by the output switching unit, outputs to the another apparatus the outputted image information; and an analyzed information output unit which, in a case where the analyzed information is outputted by the output switching unit, outputs to the another apparatus the outputted analyzed information, wherein in a case where the synthesized information is outputted by the output switching unit, either one of the image output unit and the analyzed information output unit outputs, to the another apparatus, the outputted synthesized information.

The output switching unit may select, in accordance with the information quantity of the synthesized information, which of the image output unit and the analyzed information output unit outputs the synthesized information to the other apparatus.

### Effects of Invention

As described above, according to the present invention, the privacy of a person whose image has been captured by a camera can be protected, and whether or not the camera is operating properly can be easily checked.

### BRIEF DESCRIPTION OF DRAWINGS

FIG. 1 is a diagram showing the functional configuration of an image processing apparatus pertaining to a first embodiment;

FIG. 2 is a diagram showing an example of compressed image information outputted by an image compressing unit;

FIG. 3 is a diagram showing an example of analyzed information outputted by an image analyzing unit;

FIG. 4 is a flowchart showing a flow of processing executed by the image processing apparatus pertaining to the first embodiment;

FIG. 5 is a diagram showing the functional configuration of an image processing apparatus pertaining to a second embodiment;

FIG. 6 is a diagram showing a first example of synthesized information outputted by an image synthesizing unit;

FIG. 7 is a diagram showing a second example of the synthesized information outputted by the image synthesizing unit;

FIG. 8 is a diagram showing an example data structure of the synthesized information outputted by the image synthesizing unit;

FIG. 9 is a flowchart showing a flow of processing executed by the image processing apparatus pertaining to the second embodiment;

FIG. 10 is a diagram showing the functional configuration of an image processing apparatus pertaining to a third embodiment;

FIG. 11 is a flowchart showing a flow of processing executed by the image processing apparatus pertaining to the third embodiment;

FIG. 12 is a diagram showing the functional configuration of an image processing apparatus pertaining to a fourth embodiment; and

FIG. 13 is a flowchart showing a flow of processing executed by the image processing apparatus pertaining to the fourth embodiment.

### BEST MODES FOR CARRYING OUT INVENTION

Preferred embodiments of the present invention will be described in detail below with reference to the attached drawings. In this specification and in the drawings, in regard to configural elements having substantially the same functional configurations, redundant description thereof will be omitted by assigning the same reference signs thereto.

### First Embodiment

### [Description of Configuration]

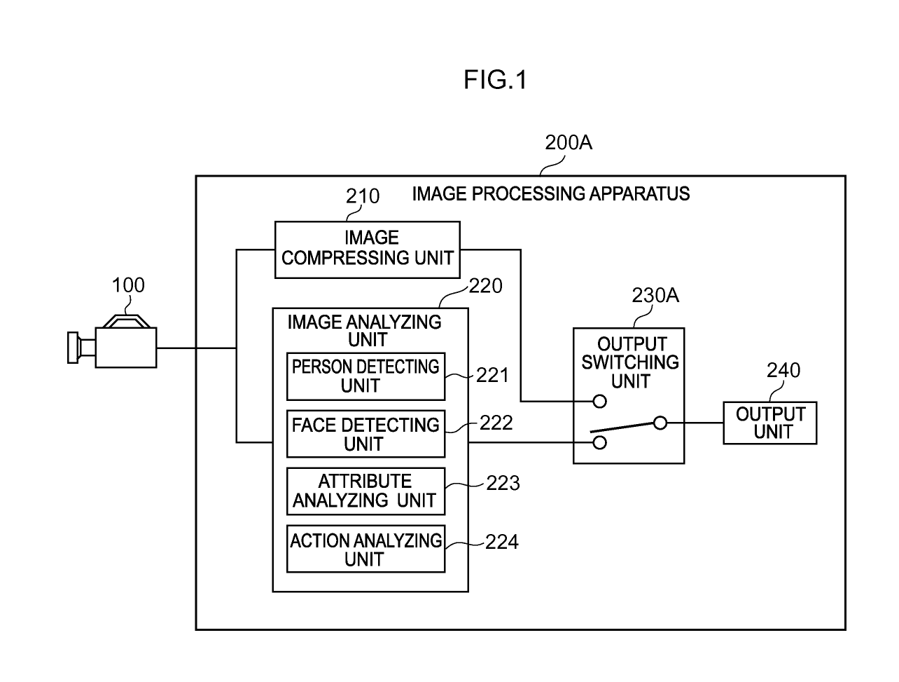

FIG. 1 is a diagram showing the functional configuration of an image processing apparatus 200A pertaining to a first embodiment. The functional configuration of the image processing apparatus 200A pertaining to the first embodiment will be described with reference to FIG. 1. As shown in FIG. 1, a camera 100 is connected to the image processing apparatus 200A and has the function of acquiring image information by capturing an image and outputting the image information to the image processing apparatus 200A.

The image processing apparatus 200A processes the image information that the camera 100 has acquired and outputted. As shown in FIG. 1, the image processing apparatus 200 is provided with an image compressing unit 210, an image analyzing unit 220, an output switching unit 230A, and an output unit 240.

The image compressing unit 210 has the functioning of acquiring compressed image information by compressing the image information that has been outputted by the camera 100. Further, the image compressing unit 210 has the function of outputting the compressed image information it has acquired. The image compressing unit 210 can use, as the compression method, existing image compression methods such as, for example, MPEG (Moving Picture Experts Group)-2, MPEG-4, JPEG (Joint Photographic Experts Group), Motion-JPEG, and image decimation. The image compressing unit 210 compresses the image information using a compression format that conforms to the standard with which the output unit 240 complies, and the image compressing unit 210 outputs the compressed image information that has been acquired by compressing the image information.

The image analyzing unit 220 has the function of acquiring analyzed information by analyzing the image information that has been outputted by the camera 110. Further, the image analyzing unit 220 has the function of outputting the analyzed information it has acquired. The analysis that the image analyzing unit 220 performs is not particularly limited. For example, the image analyzing unit 220 may be provided with a person detecting unit 221. The person detecting unit 221 detects a person existing in the image and acquires person position information (person coordinate information) for designating the position, in the image, of the person it has detected.

In a case where the image analyzing unit 220 is provided with the person detecting unit 221, the image analyzing unit 220 outputs, as the analysis result, the person position information that has been acquired by the person detecting unit 221. The technique for the person detecting unit 221 to detect the person is not particularly limited. As the technique for the person detecting unit 221 to detect the person, for example, the technique described in JP-A No. 8-221668 may be used. The person position information that has been acquired by the person detecting unit 221 is, for example, position information representing top left and bottom right positions, in the image, of a rectangular region including the person, but the person position information is not limited to this.

For example, the image analyzing unit 220 may be provided with a face detecting unit 222. The face detecting unit 222 detects the face of a person existing in the image and acquires face position information (face coordinate information) for designating the position, in the image, of the face it has detected. In a case where the image analyzing unit 220 is provided with the face detecting unit 222, the image analyzing unit 220 outputs, as the analysis result, the face position information that has been acquired by the face detecting unit 220. The technique for the face detecting unit 222 to detect the face is not particularly limited. As the technique for the face detecting unit 222 to detect the face, for example, in a case where the image analyzing unit 220 is provided with the person detecting unit 221, a technique that cuts out the face region from the person that has been detected by the person detecting unit 221 may be used.

Further, for example, the technique described in “Rapid Object Detection using a Boosted Cascade of Simple Features” by Paul Viola and Michael Jones in Proceedings of the 2001 IEEE Computer Society Conference on Computer Vision and Pattern Recognition (CVPR '01), pp. 511-518, 2001, may be used. The face position information that has been acquired by the face detecting unit 222 is, for example, position information representing top left and bottom right positions, in the image, of a rectangular region including the face, but the face position information is not limited to this.

For example, the image analyzing unit 220 may be provided with an attribute analyzing unit 223 in addition to the face detecting unit 222. The attribute analyzing unit 223 acquires attribute information representing attributes of the person by analyzing the face in the position designated by the face position information that has been acquired by the face detecting unit 222. The attribute information is information relating to that person, such as sex, age, and race, but the attribute information is not particularly limited. In a case where the image analyzing unit 220 is equipped with the attribute analyzing unit 223, the image analyzing unit 220 outputs, as the analysis result, the attribute information that has been acquired by the attribute analyzing unit 223. The technique for the attribute analyzing unit 223 to analyze the face is not particularly limited. As the technique for the attribute analyzing unit 223 to analyze the face, for example, the technique described in “Estimation system of sex and age by Gabor wavelet conversion and support vector machine” by Satoshi Hosoi, Erina Takikawa, and Masato Kawade in Collection of Lecture in the Eighth Symposium on Sensing via Image Information (SSII), pp. 243-246, can be used. Further, as the technique for the attribute analyzing unit 223 to analyze the face, the technique described in “Ethnicity estimation with Facial Image” by Satoshi Hosoi, Erina Takikawa, and Masato Kawade in Shingaku gihō (Technical Report of Institute of Electronics, Information and communication Engineers (IEICE)) PRMU 2003-143, pp. 19-24, may be used.

The image analyzing unit 220 may be provided with an action analyzing unit 224 in addition to the person detecting unit 221. The action analyzing unit 224 acquires action information representing an action of the person by analyzing the person in the position designated by the person position information that has been acquired by the person detecting unit 221. The action information is, for example, text information—such as “standing,” “sitting,” or “raising a hand”—representing the action of the person, but the action information is not particularly limited. The image analyzing unit 220 outputs, as the analyzed information, the action information that has been acquired by the action analyzing unit 224. The technique for the action analyzing unit 224 to analyze the person is not particularly limited. As the technique for the action analyzing unit 224 to analyze the person, for example, the technique described in JP-A No. 11-296673 may be used.

The image analyzing unit 220 may acquire time information representing the time when the image information has been acquired or the time when the image information has been analyzed and further output the time information it has acquired. In a case where, for example, time information representing the time when the image information has been acquired is added by the camera 100 to the image information, the image analyzing unit 220 acquires the time information and further outputs the time information it has acquired. Further, in a case where, for example, the image analyzing unit 220 itself manages time information (e.g., time information representing the current time), the image analyzing unit 220 may acquire the time information managed by itself and further output, as time information representing the time when the image information has been analyzed, the time information it has acquired.

The output switching unit 230A has the function of outputting, as output information, either one of the compressed image information that has been outputted by the image compressing unit 210 and the analyzed information that has been outputted by the image analyzing unit 220. Further, the output switching unit 230A may receive a selection from a user and output, as the output information, either one of the compressed image information and the analyzed information in accordance with the selection it has received. The output switching unit 230A is, for example, configured by a DIP switch serving as hardware. The output switching unit 230A can receive the selection from the user by the DIP switch or can receive the selection from the user via a network. In addition, in a case where the output switching unit 230A outputs, as the output information, either one of the compressed image information that has been outputted by the image compressing unit 210 and the analyzed information that has been outputted by the image analyzing unit 220, the output switching unit 230A may have a function that causes the function of the configural unit that does not output to not operate. That is, if a selection is made to output the compressed image information, the output switching unit 230A causes the image analyzing unit 220 to not perform processing (e.g., the analysis of the image information), and if a selection is made to perform the processing of the image analyzing unit 220, the output switching unit 230A causes the image compressing unit 210 to not perform processing (e.g., the compression of the image information). The effect of this function appears remarkably in a case where, for example, processing by the image compressing unit 210 and the image analyzing unit 220 is executed in the same CPU. That is, if the image compressing unit 210 and the image analyzing unit 220 are caused to operate at the same time in the same CPU, both processes become slower. However, by selecting only either one as proposed here, it becomes possible to stop the processing that has not been selected and reduce the burden on the CPU so that the processing that has been selected can be performed at a higher speed.

The selection by the user may be configured in such a way that it can be made unconditionally or may be configured in such a way that it is made under a predetermined restriction. By doing so, only a qualified person can make a selection, so the privacy of a person whose image is captured can be more tightly protected, and security with respect to operation of the image processing apparatus 200A can be improved. In order to dispose such a restriction, for example, the DIP switch may be attached inside the image processing apparatus 200A to make it difficult for the DIP switch to be operated from outside the image processing apparatus 200A. Further, authentication processing may be performed with respect to the user and the selection may be received from the user via a network in a case where the authentication processing has been successful. As the authentication processing, for example, processing may have the user input a password and perform authentication processing using the inputted password, but the authentication processing is not particularly limited.

By managing the output switching unit 230A as described above, the output switching unit 230A can switch so as to output from the image processing apparatus 200A either one of the compressed image information that has been outputted from the image compressing unit 210 and the analyzed information that has been outputted from the image analyzing unit 220. Because of this configuration, the certainty of protecting the privacy of a person whose image has been captured can be increased. Further, for example, in the case of installing the camera 100, in the case of installing the camera 10 in an appropriate position and direction, it suffices to switch the output switching unit 230A so as to output the compressed image information. By doing so, the camera installer can install the camera 100 in an appropriate position and direction while viewing the image that has been captured by the camera 100. Additionally, after installation is complete, it suffices to switch the output switching unit 230A so as to output the analyzed information. By doing so, the certainty of protecting the privacy of a person whose image has been captured can be increased. In addition to this, the output switching unit 230A may be switched so as to output the compressed image information under a special condition, such as a case where there is a request from the police, and the compressed image information that has been outputted by the output switching unit 230A may be monitored or recorded.

The output unit 240 has the function of outputting, to another apparatus, the output information that has been outputted by the output switching unit 230A. As the standard with which the output unit 240 complies, a standard that matches that of the apparatus connected to the image processing apparatus 200A may be appropriately used. As the output unit 240, for example, a LAN (Local Area Network) connector, a USB (Universal Serial Bus) connector, a SD (Secure Digital) card connector, a memory stick connector, or a wireless communication device can be used. The standard is not limited as long as it is suited to the apparatus connected to the image processing apparatus 200A.

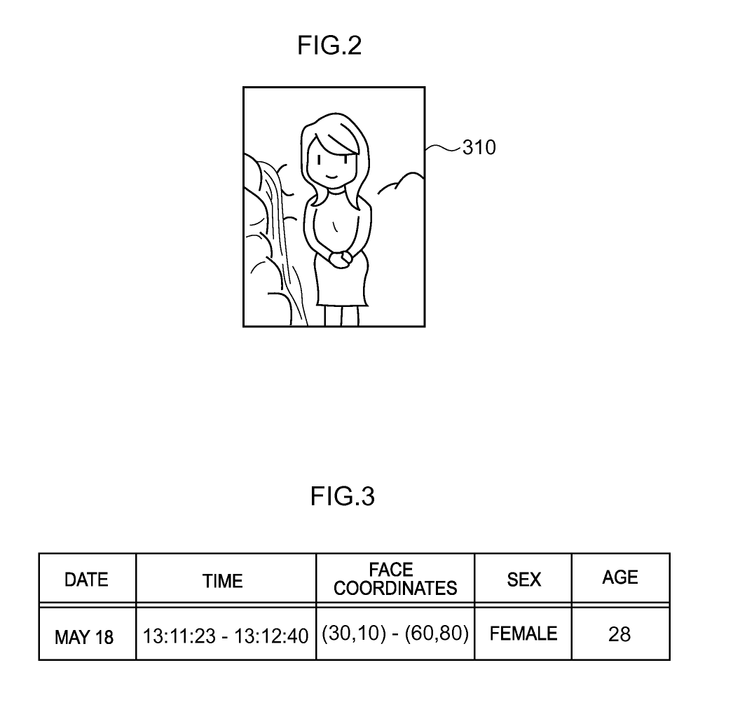

FIG. 2 is a diagram showing an example of the compressed image information outputted by the image compressing unit 210. The example of the compressed image information outputted by the image compressing unit 210 will be described with reference to FIG. 2. When the image information that has been acquired by the camera 100 is compressed by the image compressing unit 210, compressed image information 310 such as shown in FIG. 2 is generated. The image compressing unit 210 outputs the compressed image information to the output switching unit 230A.

FIG. 3 is a diagram showing an example of the analyzed information outputted by the image analyzing unit 220. The example of the analyzed information outputted by the image analyzing unit 220 will be described with reference to FIG. 3. When the analyzed information that has been acquired by the camera 100 is analyzed by the image analyzing unit 220, analyzed information such as shown in FIG. 3 is generated. In FIG. 3, as an example of the analyzed information, the date when the image has been captured by the camera 100, the time when the image has been captured, face coordinates representing the position of the face in the image, and the sex and age of the person whose image has been captured are shown. The image analyzing unit 220 outputs the analyzed information to the output switching unit 230A.

[Description of Operation]

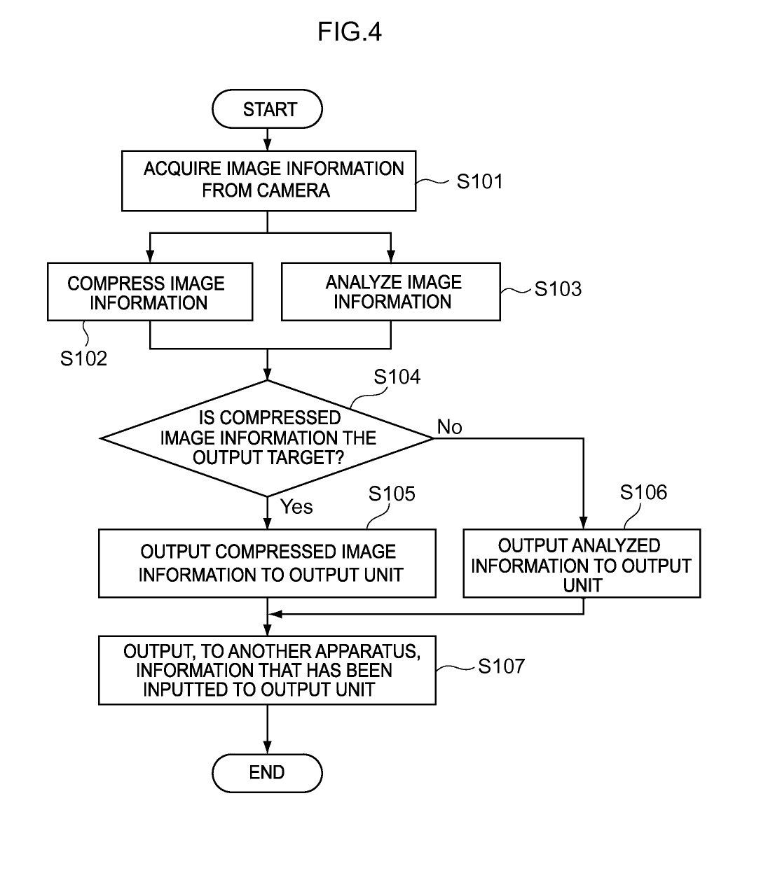

FIG. 4 is a flowchart showing a flow of processing executed by the image processing apparatus 200A pertaining to the first embodiment. The flow of processing executed by the image processing apparatus 200A pertaining to the first embodiment will be described with reference to FIG. 4.

The image processing apparatus 200A acquires image information from the camera 100 (step S101). The image compressing unit 210 acquires compressed image information by compressing the image information it has acquired from the camera 100 and outputs the compressed image information it has acquired to the output switching unit 230A (step S102). The image analyzing unit 220 acquires analyzed information by analyzing the image information it has acquired from the camera 100 and outputs the analyzed information it has acquired to the output switching unit 230A (step S103).

In case where the compressed image information is made into the output target (“Yes” in step S104), the output switching unit 230A outputs the compressed image information to the output unit 240 (step S105) and then advances to step S107. In a case where the compressed image information is not made into the output target (a case where the analyzed information is made into the output target) (“No” in step S104), the output switching unit 230A outputs the analyzed information to the output unit 240 (step S106) and then advances to step S107. The output unit 240 outputs, to another apparatus, the information that has been inputted to itself (step S107).

[Description of Effects]

According to the first embodiment, the user can select the output target by the output switching unit 230A. Because of this, while the compressed image information is output and the analyzed information is not output, whether or not the camera is operating properly can be easily checked, and while the analyzed information is output and the compressed image information is not output, it becomes possible to protect the privacy of a person whose image has been captured by the camera. Further, in the case of selecting the output target by the output switching unit 230A, by providing the output switching unit 230A with the function of stopping processing of the configural unit that has not been selected, this brings about increases in the speed and efficiency of processing, which eventually leads to a reduction in the cost of the system overall.

### Second Embodiment

### [Description of Configuration]

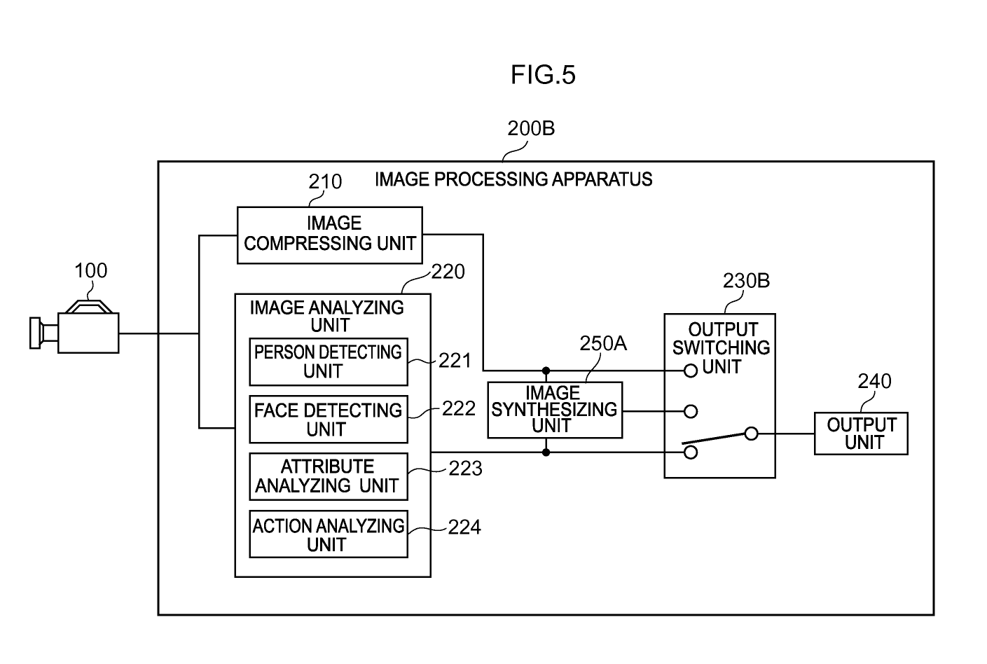

FIG. 5 is a diagram showing the functional configuration of an image processing apparatus 200B pertaining to a second embodiment. The functional configuration of the image processing apparatus 200B pertaining to the second embodiment will be described with reference to FIG. 5. As shown in FIG. 5, the image processing apparatus 200B pertaining to the second embodiment differs from the first embodiment in that the image processing apparatus 200B is further provided with an image synthesizing unit 250A and has an output switching unit 230B that differs from the output switching unit 230A in the first embodiment.

The image synthesizing unit 250A has the function of acquiring synthesized information by synthesizing the compressed image information that has been outputted by the image compressing unit 210 and the analyzed information that has been outputted by the image analyzing unit 220 and outputting the synthesized information it has acquired. The technique of synthesizing the compressed image information and the analyzed information will be described later, but it is not particularly limited.

The output switching unit 230B has the function of outputting, as output information, any one of the compressed image information that has been outputted by the image compressing unit 210, the analyzed information that has been outputted by the image analyzing unit 220, and the synthesized information that has been outputted by the image synthesizing unit 250A. Further, the output switching unit 230B may receive a selection from the user and output, as the output information, any one of the compressed image information, the analyzed information, and the synthesized information in accordance with the selection it has received. The output switching unit 230B may also, like in the first embodiment, stop the processing of configural units from which information is not outputted, except for when the output switching unit 230B outputs the synthesized information that has been outputted by the image synthesizing unit 250A. That is, if a selection is made to output the compressed image information, the output switching unit 230B causes the image analyzing unit 220 to not perform processing (e.g., the analysis of the image information) and causes the image synthesizing unit 250A to not perform processing (e.g., the synthesizing of the image information and the synthesized image), and if a selection is made to perform the processing of the image analyzing unit 220, the output switching unit 230B cause the image compressing unit 210 to not perform processing (e.g., the compression of the image information) and causes the image synthesizing unit 250A to not perform processing (e.g., the synthesizing of the image information and the synthesized image). Functions of the output switching unit 230B other than these can be realized by the same techniques as those of the output switching unit 230A, so detailed description relating to the output switching unit 230B will be omitted.

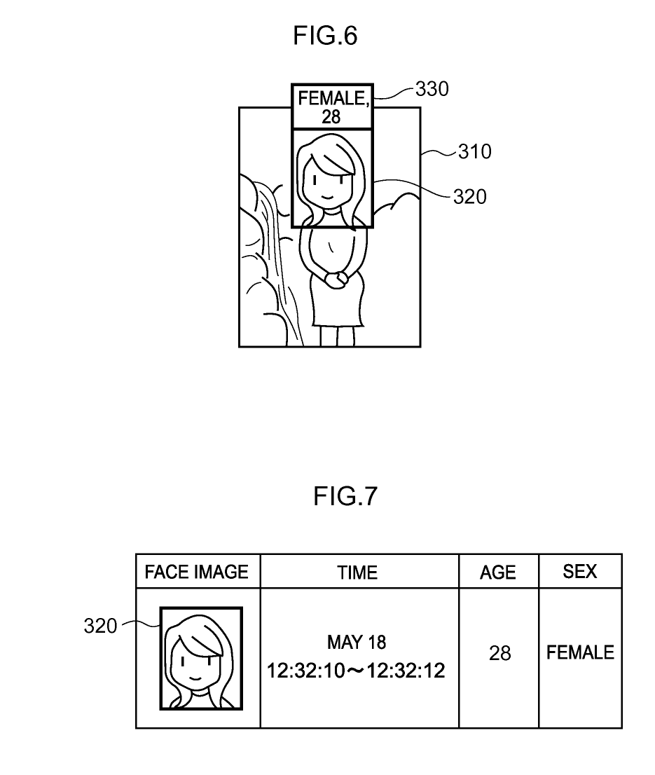

FIG. 6 is a diagram showing a first example of the synthesized information outputted by the image synthesizing unit 250A. The first example of the synthesized information outputted by the image synthesizing unit 250A will be described with reference to FIG. 6.

As shown in FIG. 6, the image synthesizing unit 250A may, for example, synthesize the compressed image information and the analyzed information by superimposing, on the compressed image information 310 that has been outputted by the image compressing unit 210, a facial region frame 320 and sex and age information 330 that have been outputted by the image analyzing unit 220. In this case, the image synthesizing unit 250A synthesizes the compressed image information and the analyzed information by writing the analyzed information on the compressed image information and outputs the synthesized result as one piece of image information.

FIG. 7 is a diagram showing a second example of the synthesized information outputted by the image synthesizing unit 250A. The second example of the synthesized information outputted by the image synthesizing unit 250A will be described with reference to FIG. 7.

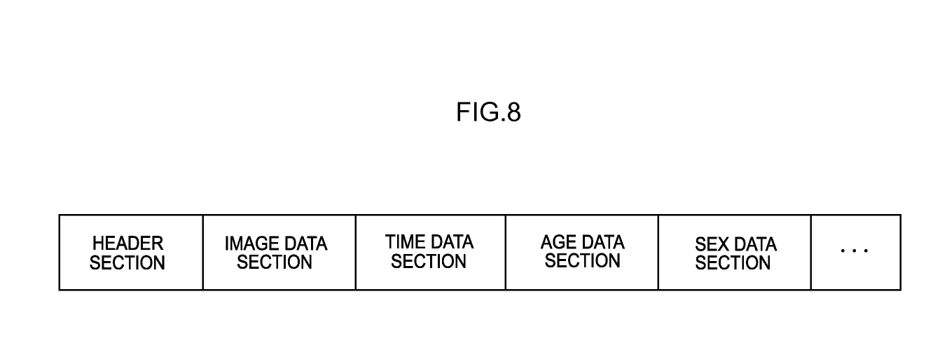

As shown in FIG. 7, the image synthesizing unit 250A may, for example, synthesize the compressed image information and the analyzed information by lining up the compressed image information 310 that has been outputted by the image compressing unit 210 and the time, age, and sex that have been outputted by the image analyzing unit 220. In this case, it suffices for the image synthesizing unit 250A to output, for example, the synthesized information as binary data in a predetermined format (e.g., see FIG. 8) and create display data such as shown in FIG. 7 on the basis of the binary data using software or the like.

FIG. 8 is a diagram showing an example data structure of the synthesized information outputted by the image synthesizing unit 250A. The example data structure of the synthesized information outputted by the image synthesizing unit 250A will be described with reference to FIG. 8.

The image synthesizing unit 250A may output the synthesized information as binary data in a format such as shown in FIG. 8. Included in the format are a header section, an image data section, a time data section, an age data section, a sex data section, and so forth, but the format may include any data sections.

[Description of Operation]

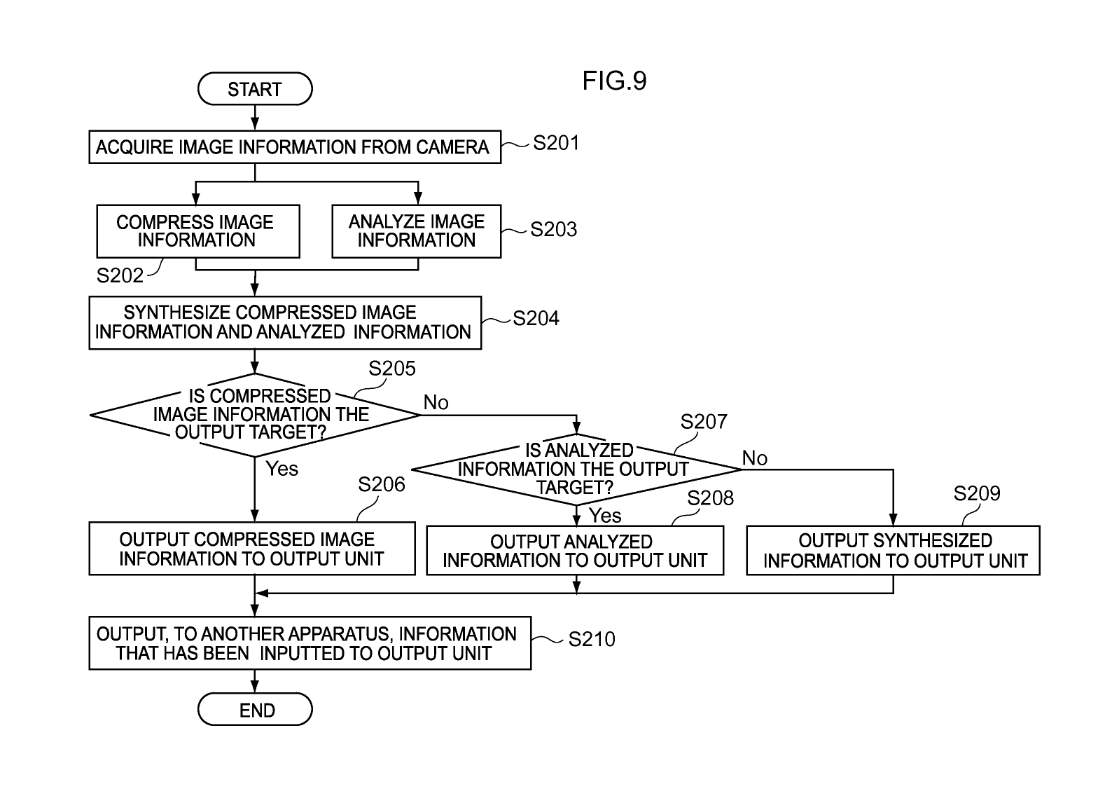

FIG. 9 is a flowchart showing a flow of processing executed by the image processing apparatus 200B pertaining to the second embodiment. The flow of processing executed by the image processing apparatus 200B pertaining to the second embodiment will be described with reference to FIG. 9.

The image processing apparatus 200B acquires image information from the camera 100 (step S201). The image compressing unit 210 acquires compressed image information by compressing the image information it has acquired from the camera 100 and outputs the compressed image information it has acquired to the output switching unit 230B (step S202). The image analyzing unit 220 acquires analyzed information by analyzing the image information it has acquired from the camera 100 and outputs the analyzed information it has acquired to the output switching unit 230B (step S203). The image synthesizing unit 250A acquires synthesized information by synthesizing the compressed image information and the analyzed information and outputs the synthesized information it has acquired to the output switching unit 230B (step S204).

In case where the compressed image information is made into the output target (“Yes” in step S205), the output switching unit 230B outputs the compressed image information to the output unit 240 (step S206) and then advances to step S210. In a case where the compressed image information is not made into the output target (a case where the analyzed information or the synthesized information is made into the output target) (“No” in step S205), the output switching unit 230B advances to step S207.

In a case where the analyzed information is made into the output target (“Yes” in step S207), the output switching unit 230B outputs the analyzed information to the output unit 240 (step S208) and then advances to step S210. In a case where the analyzed information is not made into the output target (a case where the synthesized information is made into the output target) (“No” in step S207), the output switching unit 230B outputs the synthesized information to the output unit 240 (step S209) and then advances to step S210. The output unit 240 outputs, to another apparatus, the information that has been inputted to itself (step S210).

[Description of Effects]

According to the second embodiment, the image processing apparatus 200B is further provided with the image synthesizing unit 250A, whereby it becomes possible to output the synthesized information in which the compressed image information and the analyzed information are synthesized. Because of this, the compressed image information and the analyzed information can be simultaneously referenced, so in a case where, for example, the compressed image information and the analyzed information do not match even though the camera 100 is operating properly, the fact that the image analyzing unit 220 is not operating normally can be detected. By checking the degree to which the compressed image information and the analyzed information match under a situation where the camera 100 is operating properly, an evaluation of accuracy with respect to the operation of the image analyzing unit 220 and the effects resulting from the operation of the image analyzing unit 220 can be easily gauged.

Further, in a case where, for example, the compressed image information and the analyzed information do not match even though the image analyzing unit 220 is operating normally, the fact that the camera 100 is not operating properly can be detected. Moreover, by checking the degree to which the compressed image information and the analyzed information match under a situation where the image analyzing unit 220 is operating normally, installation of the camera 100 can be easily and exactly performed.

### Third Embodiment

### [Description of Configuration]

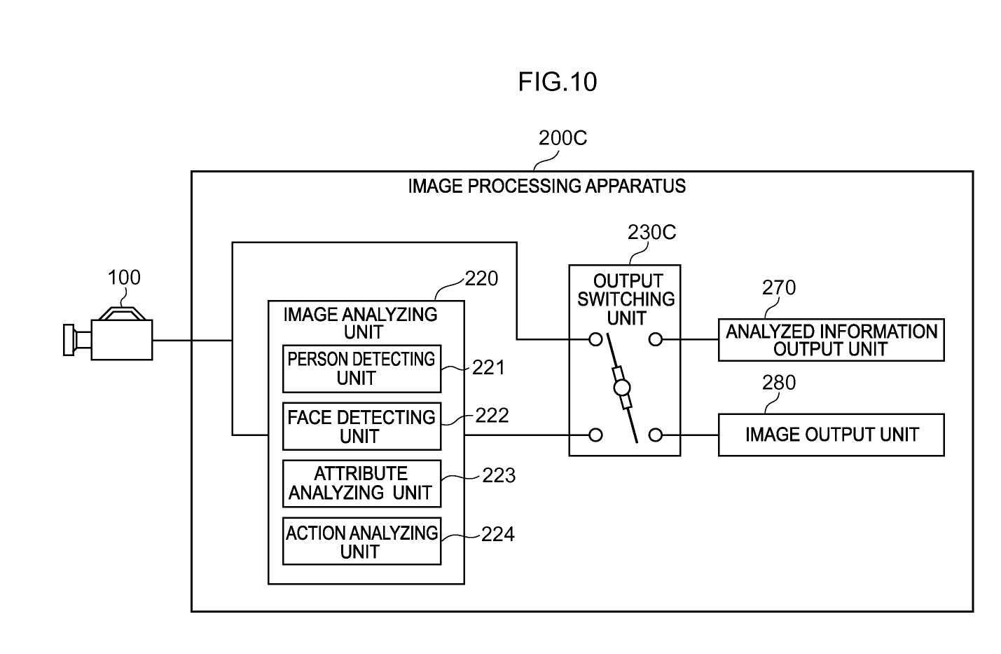

FIG. 10 is a diagram showing the functional configuration of an image processing apparatus 200C pertaining to a third embodiment. The functional configuration of the image processing apparatus 200C pertaining to the third embodiment will be described with reference to FIG. 10. As shown in FIG. 10, the image processing apparatus 200C pertaining to the third embodiment differs from the first embodiment in that the image processing apparatus 200C is not provided with the image compressing unit 210, is provided with an analyzed information output unit 270 and an image output unit 280 instead of the output unit 240, and has an output switching unit 230C that differs from the output switching unit 230A in the first embodiment.

In the first embodiment, the image processing apparatus 200A is provided with the image compressing unit 210, whereby the output unit 240 may output, with a connector of the same standard (e.g., a LAN connector) or the like, the analyzed information outputted from the image analyzing unit 220 and the compressed image information outputted from the image compressing unit 210. In the third embodiment, the image processing apparatus 200C is not provided with the image compressing unit 210, so it is necessary for the image processing apparatus 200C to output the image information to another apparatus without compressing the image information. Consequently, the analyzed information output unit 270 that outputs the analyzed information to another apparatus and the image output unit 280 that outputs the image information to another apparatus are disposed in the image processing apparatus 200C.

The output switching unit 230C has the function of outputting either one of the image information that has been outputted by the camera 100 and the analyzed information that has been outputted by the image analyzing unit 220. Further, the output switching unit 230C may receive a selection from the user and output, as the output information, either one of the image information and the analyzed information in accordance with the selection it has received. Further, in the case of outputting the image information, the output switching unit 230C can also stop the processing of the image analyzing unit 220. The output switching unit 230C can be realized by the same technique as that of the output switching unit 230A, so detailed description relating to the output switching unit 230C will be omitted.

The analyzed information output unit 270 has the function of outputting, in a case where the analyzed information has been outputted by the output switching unit 230C, the outputted analyzed information to another apparatus. The analyzed information output unit 270 is, for example, configured by the same standard as that of the output unit 240 in the first embodiment. That is, as the analyzed information output unit 270, for example, a LAN connector, a USB connector, a SD card connector, a memory stick connector, or a wireless communication device can be used.

The image output unit 280 has the function of outputting, in a case where the image information has been outputted by the output switching unit 230C, the outputted image information to another apparatus. It is necessary that the image output unit 280 output image information that has not been compressed, so as the image output unit 280, for example, a video connector such as a D-sub 15 pin connector or a BNC connector can be used.

[Description of Operation]

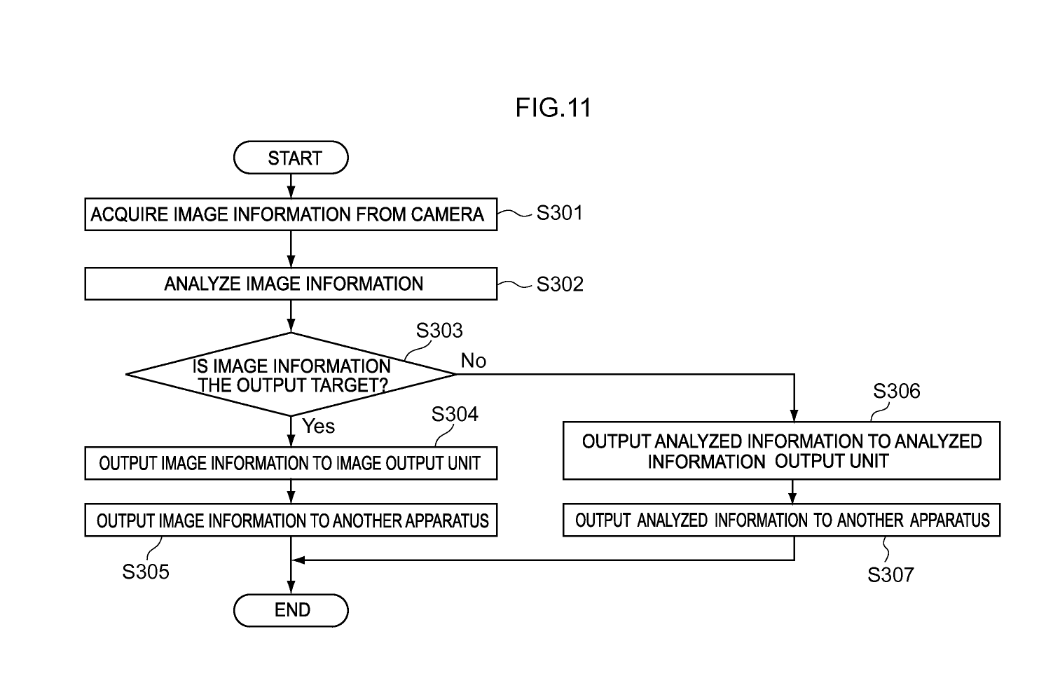

FIG. 11 is a flowchart showing a flow of processing executed by the image processing apparatus 200C pertaining to the third embodiment. The flow of processing executed by the image processing apparatus 200C pertaining to the third embodiment will be described with reference to FIG. 11.

The image processing apparatus 200C acquires image information from the camera 100 (step S301). The image analyzing unit 220 acquires analyzed information by analyzing the image information it has acquired from the camera 100 and outputs the analyzed information it has acquired to the output switching unit 230C (step S302).

In case where the image information is made into the output target (“Yes” in step S303), the output switching unit 230C outputs the image information to the image output unit 240 (step S304), and the image output unit 280 outputs, to another apparatus, the image information that has been inputted from the output switching unit 230C (step S305).

In a case where the image information is not made into the output target (a case where the analyzed information is made into the output target) (“No” in step S303), the output switching unit 230C outputs the analyzed information to the analyzed information output unit 270 (step S306), and the analyzed information output unit 270 outputs, to another apparatus, the analyzed information that has been inputted from the output switching unit 230C (step S307).

[Description of Effects]

The image processing apparatus 200C pertaining to the third embodiment can, like the image processing apparatus 200A pertaining to the first embodiment, output either one of the image information and the analyzed information to another apparatus. Consequently, the third embodiment achieves the same effects as the first embodiment. Moreover, in that the image processing apparatus 200C pertaining to the third embodiment is not provided with the image compressing unit 210, manufacturing costs can be reduced compared to the image processing apparatus 200A pertaining to the first embodiment.

### Fourth Embodiment

### [Description of Configuration]

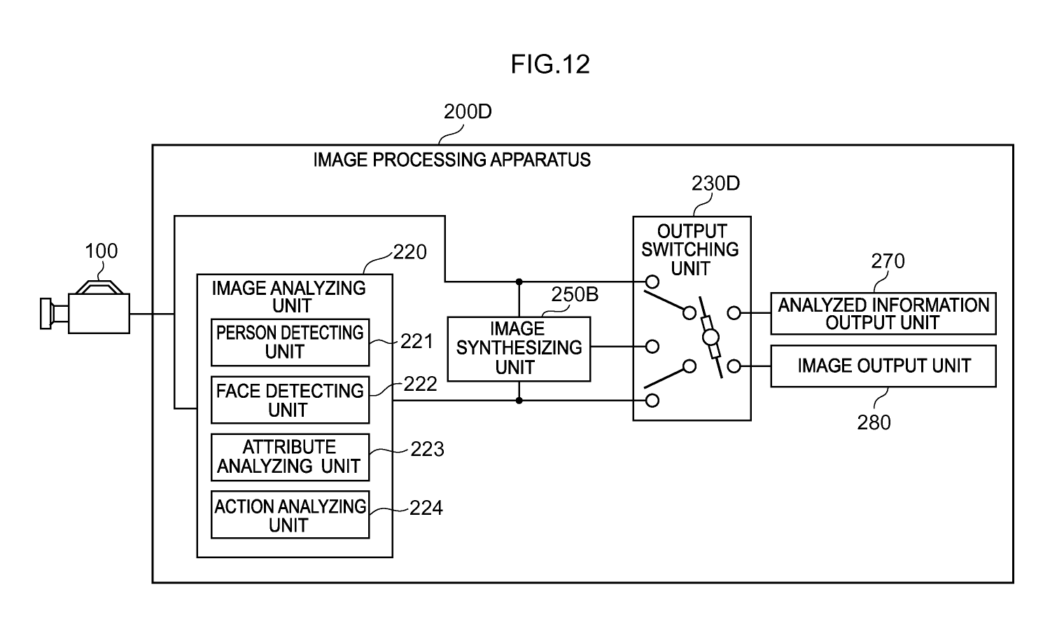

FIG. 12 is a diagram showing the functional configuration of an image processing apparatus 200D pertaining to a fourth embodiment. The functional configuration of the image processing apparatus 200D pertaining to the fourth embodiment will be described with reference to FIG. 12. As shown in FIG. 12, the image processing apparatus 200D pertaining to the fourth embodiment differs from the third embodiment in that the image processing apparatus 200D is provided with an image synthesizing unit 250B and has an output switching unit 230D that differs from the output switching unit 230C in the third embodiment.

The image synthesizing unit 250B pertaining to the fourth embodiment has the same function as that of the image synthesizing unit 250A pertaining to the second embodiment. However, the image synthesizing unit 250B differs from the image synthesizing unit 250A in that the image synthesizing unit 250B acquires synthesized information by synthesizing the image information that has been outputted by the camera 100 and the analyzed information that has been analyzed by the image analyzing unit 220 and outputting the synthesized information it has acquired. Consequently, in the fourth embodiment, the synthesized information is information in which the image information that has not been compressed and the analyzed information are synthesized, so compared to the second embodiment, there is the potential for the information quantity to become larger. Consequently, the image synthesizing unit 250B may be provided with a compressing function that is the same as or simpler than the compression format used in the image compressing unit 210. The image synthesizing unit 250B may perform simple image processing such as decimating or reducing pixels to reduce the image size and then output the synthesized information to the output switching unit 230D.

The output switching unit 230D has the function of outputting any one of the image information that has been outputted by the camera 100, the analyzed information that has been outputted by the image analyzing unit 220, and the synthesized information that has been outputted by the image synthesizing unit 250B. Like in the third embodiment, the output switching unit 230D outputs the image information that has been acquired from the camera 100 to the image output unit 280 and outputs the analyzed information that has been outputted from the image analyzing unit 220 to the analyzed information output unit 270. However, in regard to the synthesized information outputted from the image synthesizing unit 250B, it is preferred that the output switching unit 230D change the output destination in accordance with the information quantity of the synthesized information. For example, in a case where the percentage of image information occupying the synthesized information is greater than the percentage of analyzed information occupying the synthesized information, it is expected that the information quantity of the synthesized information is large, so it is suitable for the output switching unit 230D to output the synthesized information to the image output unit 280. Further, in a case where the percentage of image information occupying the synthesized information is smaller than the percentage of analyzed information occupying the synthesized information, it is expected that the information quantity of the synthesized information is small, so it is suitable for the output switching unit 230D to output the synthesized information to the analyzed information output unit 270.

Consequently, it suffices for the output switching unit 230D to select on its own, in accordance with the information quantity of the synthesized information, which of the image output unit 280 and the analyzed information output unit 270 will output the synthesized information to another apparatus. Further, the output switching unit 230D may receive a selection from the user and select, in accordance with the selection it has received, which of the image output unit 280 and the analyzed information unit 270 will output the synthesized information to another apparatus. Further, the output switching unit 230D can also stop the processing of the image analyzing unit 220 in the case of outputting only the image information.

[Description of Operation]

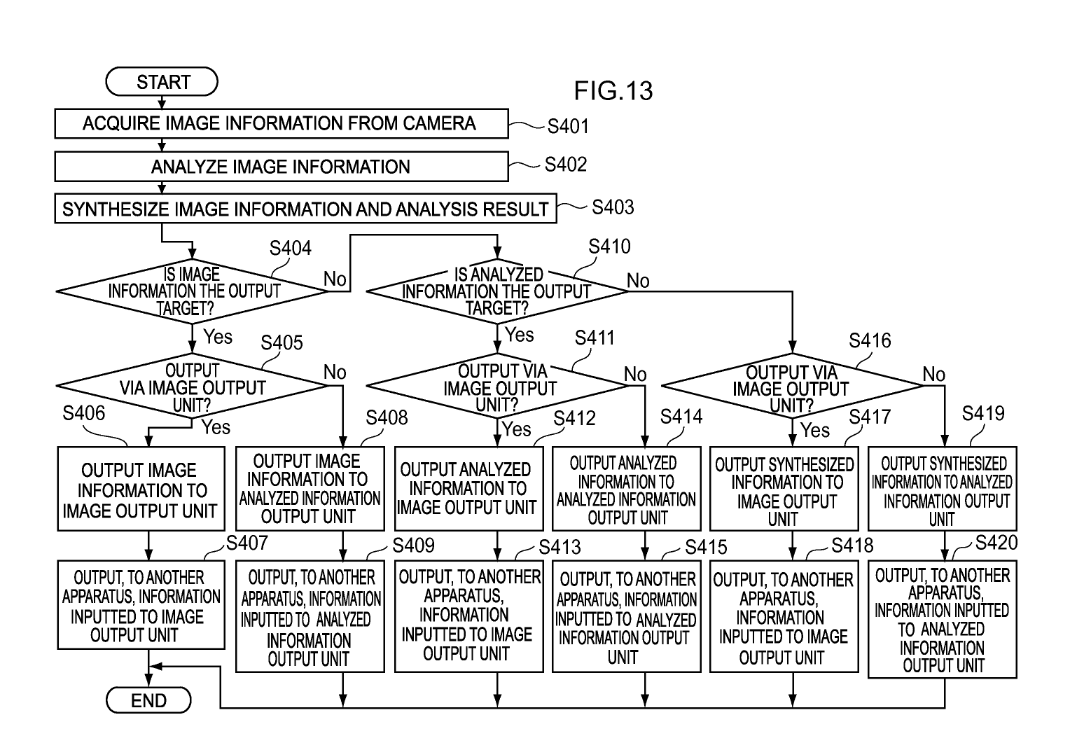

FIG. 13 is a flowchart showing a flow of processing executed by the image processing apparatus 200D pertaining to the fourth embodiment. The flow of processing executed by the image processing apparatus 200D pertaining to the fourth embodiment will be described with reference to FIG. 13.

The image processing apparatus 200D acquires image information from the camera 100 (step S401). The image analyzing unit 220 acquires analyzed information by analyzing the image information it has acquired from the camera 100 and outputs the analyzed information it has acquired to the output switching unit 230D (step S402). The image synthesizing unit 250B acquires synthesized information by synthesizing the image information and the analyzed information and outputs the synthesized information it has acquired to the output switching unit 230D (step S403).

In case where the image information is made into the output target (“Yes” in step S404), the output switching unit 230D advances to step S405. In the case of outputting via the image output unit 280 (“Yes” in step S405), the output switching unit 230D outputs the image information to the image output unit 280 (step S406), and the image output unit 280 outputs, to another apparatus, the information that has been inputted to itself (step S407). In the case of not outputting via the image output unit 280 (in the case of outputting via the analyzed information output unit 270) (“No” in step S405), the output switching unit 230D outputs the image information to the analyzed information output unit 270 (step S408), and the analyzed information output unit 270 outputs, to another apparatus, the information that has been inputted to itself (step S409).

In a case where the analyzed information or the synthesized information is made into the output target (“No” in step S404), the output switching unit 230D advances to step S410. In a case where the analyzed information is made into the output target (“Yes” in step S410), the output switching unit 230D advances to step S411. In the case of outputting via the image output unit 280 (“Yes” in step S411), the output switching unit 230D outputs the analyzed information to the image output unit 280 (step S412), and the image output unit 280 outputs, to another apparatus, the information that has been inputted to itself (step S413). In the case of not outputting via the image output unit 280 (in the case of outputting via the analyzed information output unit 270) (“No” in step S411), the output switching unit 230D outputs the analyzed information to the analyzed information output unit 270 (step S414), and the analyzed information output unit 270 outputs, to another apparatus, the information that has been inputted to itself (step S415).

In a case where the analyzed information is not made into the output target (a case where the synthesized information is made into the output target) (No” in step S410), the output switching unit 230D advances to step S416. In the case of outputting via the image output unit 280 (“Yes” in step S416), the output switching unit 230D outputs the synthesized information to the image output unit 280 (step S417), and the image output unit 280 outputs, to another apparatus, the information that has been inputted to itself (step S418). In the case of not outputting via the image output unit 280 (in the case of outputting via the analyzed information output unit 270 (“No” in step S416), the output switching unit 230D outputs the synthesized information to the analyzed information output unit 270 (step S419), and the analyzed information output unit 270 outputs, to another apparatus, the information that has been inputted to itself (step S420).

[Description of Effects]

The image processing apparatus 200D pertaining to the fourth embodiment is not provided with the image compressing unit 210, so effects that are the same as the effects achieved by the image processing apparatus 200C pertaining to the third embodiment can be achieved. Further, the image processing apparatus 200D pertaining to the fourth embodiment is equipped with the image synthesizing unit 250B, so effects that are the same as the effects achieved by the image processing apparatus 200B pertaining to the second embodiment can be achieved.

<Modifications>

Preferred embodiments of the present invention have been described above with reference to the attached drawings, but it goes without saying that the present invention is not limited to these examples. It will be apparent to persons skilled in the art that various changes or modifications can be arrived at within the category described in the claims, and it will be understood that those also belong to the technical scope of the present invention.

For example, in the first embodiment to the fourth embodiment, the image analyzing unit 220 detects a person by analyzing the image and acquires information relating to the person it has detected. However, the image analyzing unit 220 may also detect vehicles, animals, common objects, and so forth by analyzing the image and acquire information relating to the objects it has detected.

Further, the standards with which the image compressing unit 210, the output unit 240, the analyzed information output unit 270, and the image output unit 280 comply are not particularly limited and can be appropriately changed in accordance with the technology or situation at that time.

1. An image processing apparatus that processes image information that is acquired and outputted by a camera, the image processing apparatus comprising:
an image compressing unit that acquires compressed image information by compressing the image information that is outputted by the camera and outputs the acquired compressed image information;
an image analyzing unit that acquires analyzed information by analyzing the image information that is outputted by the camera and outputs the acquired analyzed information;
an output switching unit that outputs, as output information, either one of the compressed image information that is outputted by the image compressing unit and the analyzed information that is outputted by the image analyzing unit; and
an output unit that outputs, to another apparatus, the output information that is outputted by the output switching unit.

2. The image processing apparatus according to claim 1, wherein the output switching unit receives a selection from a user and outputs, as the output information, either one of the compressed image information and the analyzed information in accordance with the received selection.

3. The image processing apparatus according to claim 1, wherein in a case where the output switching unit outputs the compressed image information as the output information, the output switching unit causes the image analyzing unit to not perform analysis of the image information, and in a case where the output switching unit outputs the analyzed information as the output information, the output switching unit causes the image compressing unit to not perform compression of the image information.

4. The image processing apparatus according to claim 3, wherein the output switching unit performs authentication processing with respect to the user and receives the selection from the user in a case where the authentication processing is successful.

5. The image processing apparatus according to claim 1, wherein
the image analyzing unit comprises a person detecting unit that detects a person existing in an image represented by the image information and acquires person position information for designating a position, in the image, of the detected person, and
the image analyzing unit outputs the analyzed information including the person position information that is acquired by the person detecting unit.

6. The image processing apparatus according to claim 1, wherein
the image analyzing unit comprises a face detecting unit that detects the face of a person existing in an image represented by the image information and acquires face position information for designating a position, in the image, of the detected face, and
the image analyzing unit outputs the analyzed information including the face position information that is acquired by the face detecting unit.

7. The image processing apparatus according to claim 1, wherein
the image analyzing unit comprises
a face detecting unit that detects the face of a person existing in an image represented by the image information and acquires face position information for designating a position, in the image, of the detected face, and
an attribute analyzing unit that acquires attribute information representing attributes of the person by analyzing the face in the position designated by the face position information that is acquired by the face detecting unit, and
the image analyzing unit outputs the analyzed information including the attribute information that is acquired by the attribute analyzing unit.

8. The image processing apparatus according to claim 1,
wherein the image analyzing unit comprises
a person detecting unit that detects a person existing in an image represented by the image information and acquires person position information for designating a position, in the image, of the detected person, and
an action analyzing unit that acquires action information representing an action of the person by analyzing the person in the position designated by the person position information that has been acquired by the person detecting unit, and
wherein the image analyzing unit outputs the analyzed information including the action information that is acquired by the action analyzing unit.

9. The image processing apparatus according to claim 1, wherein the image analyzing unit acquires time information representing a time when the image information has been acquired or a time when the image information has been analyzed and outputs the analyzed information including the acquired time information.

10. An image processing apparatus that processes image information that is acquired and outputted by a camera, the image processing apparatus comprising:
an image compressing unit that acquires compressed image information by compressing the image information that is outputted by the camera and outputs the acquired compressed image information;
an image analyzing unit that acquires analyzed information by analyzing the image information that is outputted by the camera and outputs the acquired analyzed information;
an image synthesizing unit that acquires synthesized information by synthesizing the compressed image information that is outputted by the image compressing unit and the analyzed information that is outputted by the image analyzing unit and outputs the acquired synthesized information;
an output switching unit that outputs, as output information, any one of the compressed image information that is outputted by the image compressing unit, the analyzed information that is outputted by the image analyzing unit, and the synthesized information that is outputted by the image synthesizing unit; and
an output unit that outputs, to another apparatus, the output information that is outputted by the output switching unit.

11. The image processing apparatus according to claim 10, wherein in a case where the output switching unit outputs the compressed image information as the output information, the output switching unit causes the image analyzing unit to not perform analysis of the image information and causes the image synthesizing unit to not perform synthesis of the compressed image information and the analyzed information, and in a case where the output switching unit outputs the analyzed information as the output information, the output switching unit causes the image compressing unit to not perform compression of the image information and causes the image synthesizing unit to not perform synthesis of the compressed image information and the analyzed information.

12. An image processing apparatus that processes image information that is acquired and outputted by a camera, the image processing apparatus comprising:
an image analyzing unit that acquires analyzed information by analyzing the image information that is outputted by the camera and outputs the acquired analyzed information;
an output switching unit that outputs either one of the image information that is outputted by the camera and the analyzed information that is outputted by the image analyzing unit;
an image output unit which, in a case where the image information is outputted by the output switching unit, outputs to another apparatus the outputted image information; and
an analyzed information output unit which, in a case where the analyzed information has been outputted by the output switching unit, outputs to the another apparatus the outputted analyzed information.

13. An image processing apparatus that processes image information that is acquired and outputted by a camera, the image processing apparatus comprising:
an image analyzing unit that acquires analyzed information by analyzing the image information that is outputted by the camera and outputs the acquired analyzed information;
an image synthesizing unit that acquires synthesized information by synthesizing the image information that is outputted by the camera and the analyzed information that is outputted by the image analyzing unit and outputs the acquired synthesized information;
an output switching unit that outputs any one of the image information that is outputted by the camera, the analyzed information that is outputted by the image analyzing unit, and the synthesized information that is outputted by the image synthesizing unit;
an image output unit which, in a case where the image information is outputted by the output switching unit, outputs to another apparatus the outputted image information; and
an analyzed information output unit which, in a case where the analyzed information is outputted by the output switching unit, outputs to the another apparatus the outputted analyzed information,
wherein in a case where the synthesized information is outputted by the output switching unit, either one of the image output unit and the analyzed information output unit outputs, to the another apparatus, the outputted synthesized information.

14. The image processing apparatus according to claim 13, wherein the output switching unit selects, in accordance with the information quantity of the synthesized information, which of the image output unit and the analyzed information output unit outputs the synthesized information to the another apparatus.

15. An image processing method by an image processing apparatus that processes image information that is acquired and outputted by a camera, the image processing method comprising:
acquiring compressed image information by compressing the image information that is outputted by the camera and outputs the acquired compressed image information;
acquiring analyzed information by analyzing the image information that is outputted by the camera and outputs the acquired analyzed information;
outputting, as output information, either one of the compressed image information that is outputted and the analyzed information that is outputted; and
outputting, to another apparatus, the output information that is outputted.

16. The image processing apparatus according to claim 2, wherein the output switching unit performs authentication processing with respect to the user and receives the selection from the user in a case where the authentication processing is successful.
